(19) United States
(12) Patent Application Publication
(10) Pub. No.: US 2012/0318899 A1
(43) Pub. Date: Dec. 20, 2012

(54) BOTTLE CRUSHER

(75) Inventor: Timothy James Fulton Barnett, Blenheim (NZ)

(73) Assignee: EXPLECO LIMITED, Blenheim (NZ)

(21) Appl. No.: 13/581,607

(22) PCT Filed: Mar. 1, 2011
(86) PCT No.: PCT/IB2011/050872

§ 371 Date: Aug. 28, 2012

(30) Foreign Application Priority Data
Mar. 2, 2010 (NZ) 583653

(51) Int. Cl. B02C 13/26; B02C 13/284; B02C 13/288; B02C 13/30; B02C 13/286

(52) U.S. Cl. 241/60; 241/99; 241/86

(57) ABSTRACT

Bottle crusher with a feed section, a crushing section, a collection section and a venting section, wherein the crushing section is essentially a hammer mill with a crushing assembly inside a drum; such that: —the crushing assembly includes a plurality of hammers, an assembly shaft and at least two hammer shafts; —each hammer shaft lies essentially parallel to, and is spaced equidistantly from, the assembly shaft to which it is attached; —each hammer includes a hammer tail and a hammer head at opposite distal ends of said hammer, such that each hammer tail is hingedly connected to one hammer shaft; and—the drum and crushing assembly have essentially co-incident centrelines; wherein the drum includes a void section which is an indentation in the inner surface of the drum, in cross-section across the drum, configured to create a reduced pressure in the feed section, when in use.

### TECHNICAL FIELD

The present invention relates to a comminution device; more specifically a hammer mill for breaking up glass bottles and containers to reduce the storage and transport volume.

### BACKGROUND ART

Glass bottles and containers once empty can create a storage and/or disposal problem. Though glass is recyclable only so much is needed for this purpose and the rest needs to be disposed of. Landfill disposal of the waste glass is problematic, unless broken down and disposed of properly it occupies a large volume and can be a safety hazard.

The safe storage and transport of spent glass containers can be especially difficult for businesses that operate in the food and beverages industry. Bars, cafes, restaurants, casinos and hotels regularly empty large numbers of glass containers, as do large sports and entertainment events, all of which need to be disposed of. The most common method of disposing of the glass containers at present is by throwing them into a bin for collection (often recycling). As a percentage of the containers break in use, or as they are thrown into the bins, care needs to be taken. Those throwing the containers away, or handling the bins need to be careful or injuries can result.

Glass containers, even with a proportion broken, occupy a large volume relative to their weight so businesses face the expense of storing and disposing of the bins which are largely air. For this reason a number of onsite bottle crushers have been developed. Some of the onsite bottle crushers succeed in reducing the volume but result in glass fragments, shards and pieces, often with razor sharp edges, sometimes with very fine pieces and dust present. This material can be useful as cullet (waste glass for the use in producing new glass), but often needs further processing for other purposes.

Many of the glass crushers currently available produce cullet (approximately serving spoon size) which is useful for recycling. Without careful sorting (colour and type) it is difficult to use all of this material, and even if sorted the transport costs to ship this to a remanufacturing plant can make it uneconomical to re process, in this case the cullet often ends up in landfill sites.

Any discussion of the prior art throughout the specification is not an admission that such prior art is widely known or forms part of the common general knowledge in the field.

It would be advantageous if the invention could overcome one or more of the deficiencies in present bottle crushing devices.

Where the term bottle, or bottles, is used it is intended to include glass containers of all shapes and sizes, for example jars, vases, etc. Most likely the bottles are used in bars, cafes, restaurants, hotels, casinos or similar.

### DISCLOSURE OF INVENTION

The present invention provides a bottle crusher that includes a feed section, a crushing section, a collection section and a venting section.

Preferably the crushing section is essentially a hammer mill with a crushing assembly inside a drum; such that:—
the crushing assembly includes a plurality of hammers, an assembly shaft and at least two hammer shafts;
each hammer shaft lies essentially parallel to, and is spaced equidistantly from, the assembly shaft to which it is attached;
each hammer includes a hammer tail and a hammer head at opposite distal ends of said hammer, such that each hammer tail is hingedly connected to one hammer shaft; and the drum and crushing assembly have essentially coincident centrelines.

Preferably the drum includes a void section which is an indentation in the inner surface of the drum, when viewed in cross-section across the drum, configured to create a reduced pressure in the feed section, when the crushing section is in use.

Preferably the void section is an indentation in an inner surface of the drum extending, when viewed in cross-section across the drum, from approximately the 9 o'clock position to the 12 o'clock position on an analogue clock. In a highly preferred form the void section smoothly curves away from the centre of the drum to a point located at between about the 11:00 o'clock position and 11:45 o'clock position on an analogue clock, then smoothly transitions back to a point on the edge of the circle the same diameter as the drum.

Preferably for a drum with a radius of 104 cm the maximum void section depth, at close to about the 11:30 o'clock position on an analogue clock, is between 20 mm and 60 mm. In a more preferred form the depth is between about 30 mm and 50 mm.

Preferably the crushing assembly includes at least two assembly plates, such that each hammer shaft is attached to the assembly shaft by the assembly plates, said assembly plates are spaced along the length of the of the assembly shaft, wherein each hammer is located between two immediately adjacent assembly plates. In a highly preferred form each of the hammer shafts is equispaced around the periphery of the assembly plates. In a further preferred form each assembly plate is shaped like an equilateral triangle with rounded vertices with a hammer shaft located close to each vertex.

Preferably each hammer is, when viewed from the front, “I” shaped, with one cross bar longer than the other, the longer cross bar corresponding to the hammer head and the shorter cross bar corresponding to the hammer tail.

Preferably the bottle crusher is a substantially sealed unit configured to operate with a slightly reduced pressure in the feed section and vent essentially all air exiting through the venting section.

Preferably the collection section includes a container configured to collect the crushed glass from the crushing section. Preferably the venting section is configured to reduce the particulate load of air flowing out of the bottle crusher via the venting section. Preferably the venting section includes one or more of the following: a filter, a cyclone, an electrostatic precipitator and an oil bath, configured to reduce the particulate loading.

Preferably the drum includes a crusher screen, said crusher screen being a fully or partially perforated plate configured to co-operate with each hammer to break down a bottle being processed. Preferably the crusher screen extends, when viewed in cross-section across the drum, from approximately the 3 o'clock position to the 9 o'clock position on an analogue clock. Preferably the perforations in the plate extend essentially the full length of the crusher screen. Preferably, where perforated, the crusher screen is between about 30% and 50% void. In a highly preferred form each perforation is a hole between 7 mm and 12 mm in diameter. In a still more preferred form the crusher plate is about 6 mm thick has about 40% void and each hole is between 9 mm to 10 mm in diameter.

In one preferred form the minimum clearance between a leading edge of each hammer head, where the leading edge is the part of each hammer configured to first impact a bottle being processed, and an inner surface of the crusher screen is configured to decrease when the bottle is impacted. Preferably the minimum clearance, in the unloaded position i.e. prior to the hammer impacting the bottle, is between 5 mm and 7 mm. In a preferred form the minimum clearance, in the loaded position i.e. after the hammer has impacted the bottle, is between 2 mm and 4 mm. In a highly preferred form the unloaded clearance is about 6 mm and the loaded clearance is about 2.7 mm. It should be noted that all clearances are given in the as new condition, and wear or impact damage may change this.

Preferably the crushing assembly is driven, directly or indirectly, by a driving means.

In a highly preferred form the driving means is an electric motor configured to directly rotate the crushing assembly at about 2800 rpm. An alternative preferred form the electric motor indirectly (e.g. belt, chain, gearbox, etc) drives the crushing assembly.

Preferably the bottle crusher is configured to produce a crushed glass with 90% less than 4 mm. In a highly preferred form 65% of the crushed glass is 2 mm or less in size.

Preferably the feed section includes an inlet with at least one valve, the or each valve being configured to allow a bottle to be fed into the crushing section and assist in maintaining a reduced pressure inside the feed section. In a highly preferred form the or one valve is a resilient material, such as rubber, with a cross cut.

### BRIEF DESCRIPTION OF DRAWINGS

By way of example only, a preferred embodiment of the present invention is described in detail below with reference to the accompanying drawings, in which:

FIG. 1 is a side view of the bottle crusher;

FIG. 2 is an end view of the bottle crusher;

FIG. 3 is a partially sectioned view of the bottle crusher along the dashed line A-A on FIG. 1 in the direction of arrows;

FIG. 4 is a partially sectioned view of part of the bottle crusher along the dashed line C-C as shown in FIG. 2 in the direction of arrows;

FIG. 5 is a side view of a hammer;

FIG. 6 is an end view of a hammer, from the striking face end;

FIG. 7 is a close up sectional view of the crushing section along the dashed line B-B in the direction of arrows, with the hammers in a rest position;

FIG. 8 is a close up sectional view of the crushing section along the dashed line B-B in the direction of arrows, with the bottle crusher in use with the hammers in an operating but unloaded position; and

FIG. 9 is a close up sectional view of the crushing section along the dashed line B-B in the direction of arrows, with the bottle crusher in use and one of the hammers impacting a bottle;

### BEST MODE FOR CARRYING OUT THE INVENTION

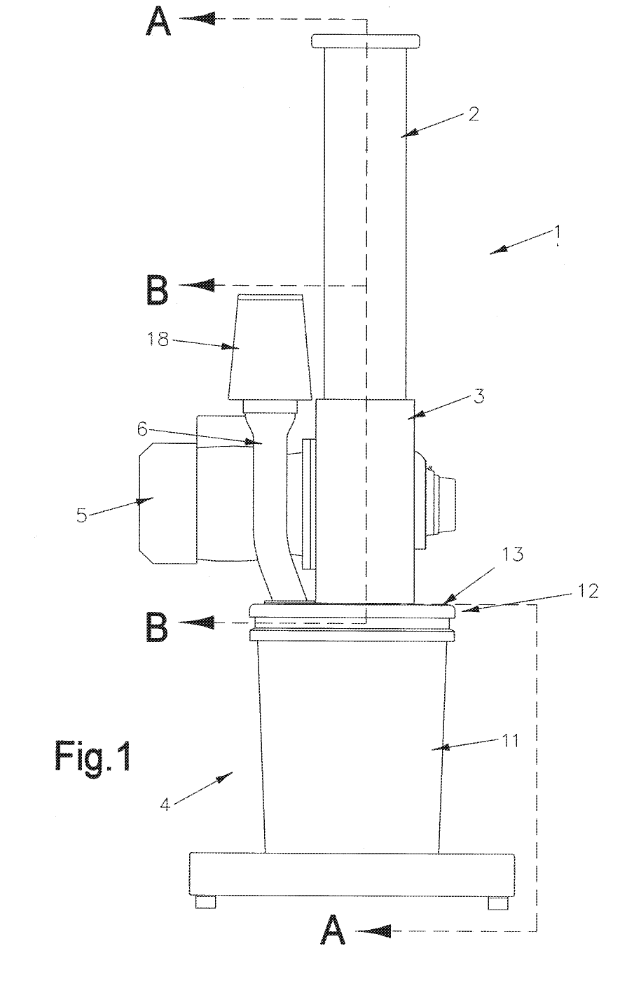

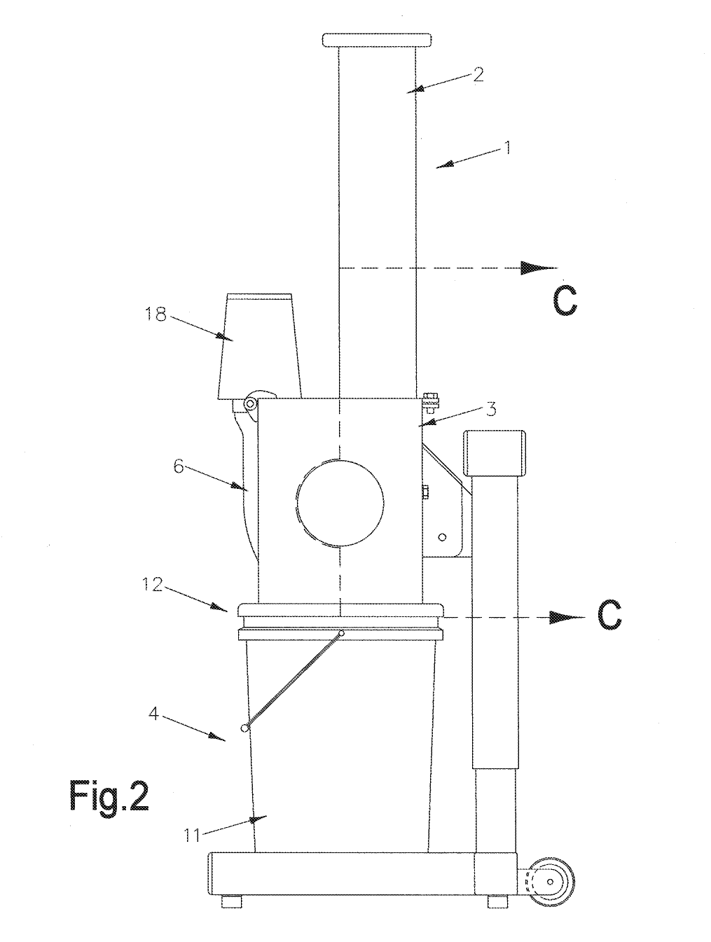

Referring to FIGS. 1 and 2 a bottle crusher (1) including a feed section (2), a crushing section (3), a collection section (4), a drive means (5) and a vent section (6) is shown. The feed section (2) allows bottles to be fed into the crushing section (3) where the bottles are broken down; the resultant crushed glass is collected in the collection section (4). The collection section (4) is vented to atmosphere by the vent section (6). In use the geometry of the crushing section (3) causes the feed section (2) to be at a slightly negative pressure; this essentially prevents any finely divided material from escaping. The drive means (5) drives the crushing section (3) via a direct or indirect connection.

The centreline of the feed section (2) is essentially perpendicular to the centreline of the crushing section (3) but horizontally offset. In addition the feed section (2) extends above the crushing section (3), so that in use the bottles are gravity fed into the crushing section (3).

The collection section (4) includes a container (11) and a connection section (12). The container (11) is a removable receptacle for the crushed glass exiting the crushing section (3), and may be a bucket or a wheelie bin (wheeled recycling container used in many countries) of known type.

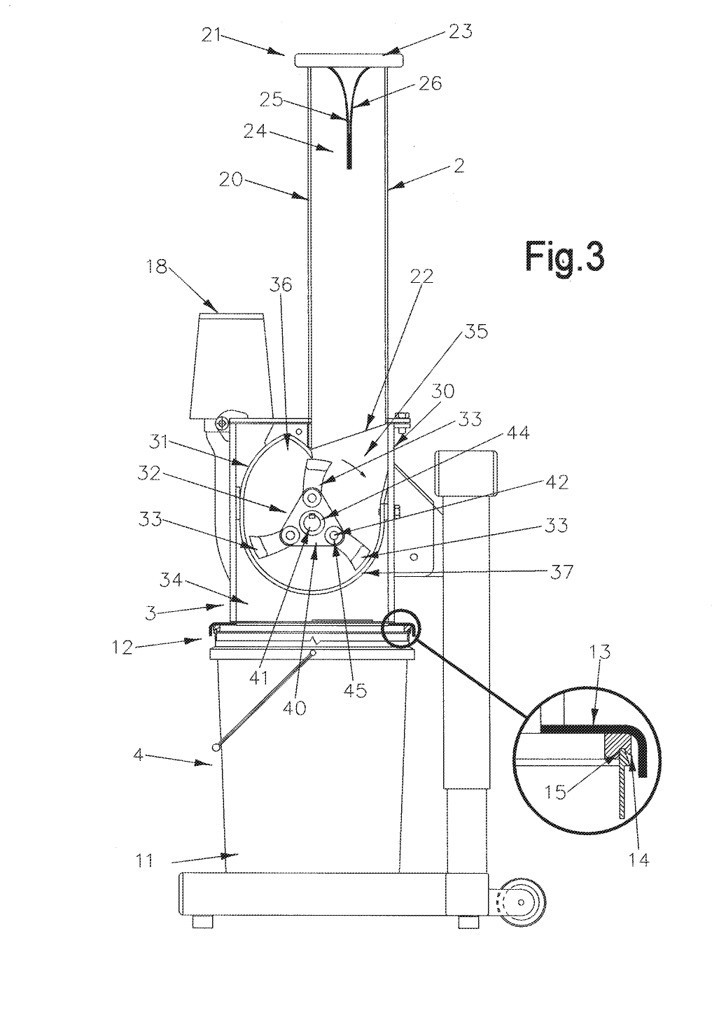

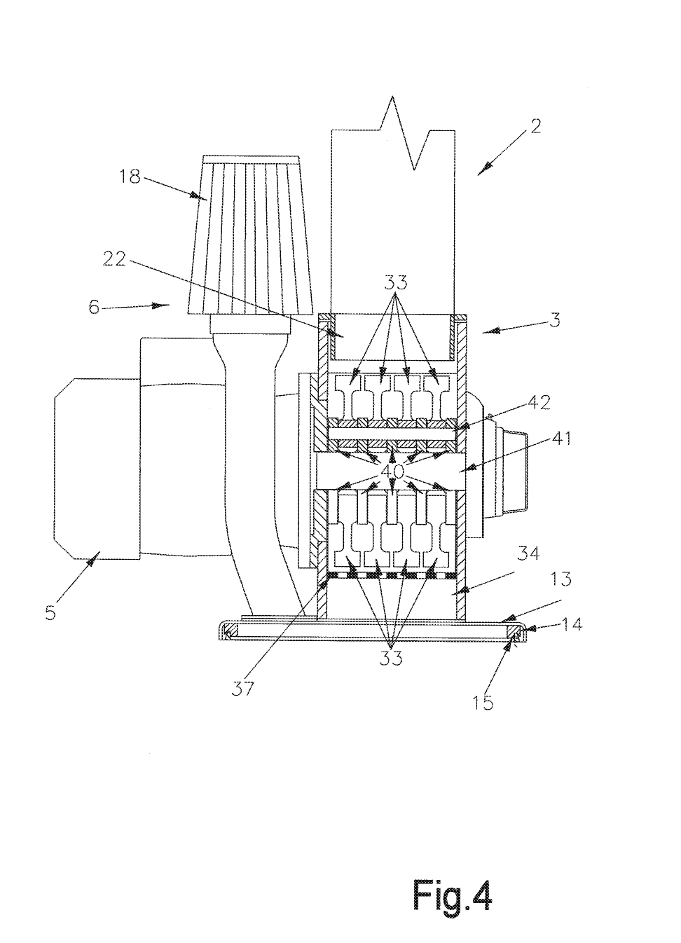

Referring to FIGS. 3 and 4 the feed section (2), the crushing section (3) and the connection section (12) are shown in cross-section. The connection section (12) includes a cover (13) including a sealing means (14). In use the sealing means (14) forms an essentially air tight releasable seal against the exposed edge (15) of the container (11). The sealing means (14) is made of a flexible and resilient material of a known type normally used to form a seal against an exposed edge.

The cover (13) is also connected to the vent section (6). The vent section (6) includes a filter (18) that, in combination with the slight negative pressure created in the feed section (2) by the crushing section (3), reduces or eliminates particulate emission from the bottle crusher (1) when it is in use. The filter (18) can be any known filtration device normally used to reduce or remove particulate matter from an air stream, for example an oil bath filter, paper filter elements, oil soaked cotton mesh, etc.

The feed section (2) is an essentially straight duct (20) including a feed inlet (21) and a feed outlet (22), each at opposite distal ends of the feed section (2). The feed inlet (21) includes two flexible valves (23,24). The first valve (23) is a sheet of flexible material with a cross cut right through the material, and the second valve (24) consists of two flaps (25,26) of a flexible material that extend into the interior of the duct (20) forming, in cross section, a ‘V’ shape. The feed outlet (22) is attached to the crushing section (3). The length of the duct (20) can vary, but in general it is long enough to prevent a user of the bottle crusher (1) from directly accessing the crushing section (3) through the feed inlet (21).

The crushing section (3) includes a casing (30), a drum (31) and a crushing assembly (32) including a plurality of hammers (33). The casing (30) is a box that surrounds the drum (31) which includes a crusher outlet (34) which is attached to the cover (13) and, in use, provides a pathway from the drum (31) to the collection section (4) for the crushed glass. The centreline of the crusher assembly (32) and the drum (31) are coincident. The drum (31) is approximately circular in cross-section, and includes a crusher inlet (35) and a void section (36).

The crusher inlet (35) is an aperture through the drum (31) extending, when viewed in cross-section across the drum (31), between the 12 o'clock and 3 o'clock position on an analogue clock, which aligns with the feed outlet (22). The crusher inlet (35) extends along the length of the drum (31) as does the feed outlet (22), though this may vary depending on the size of the bottle crusher (1).

The void section (36) is an indentation in an inner surface of the drum (31) extending, when viewed in cross-section across the drum (31), from approximately the 9 o'clock position to the 12 o'clock position on an analogue clock. The void section (36), in cross section, smoothly curves away from the edge of a circle the same diameter as the drum (31) to a point located at about the 11:30 o'clock position on an analogue clock (though this is only approximate), then smoothly transitions back to a point on the edge of the circle the same diameter as the drum (31). For a drum (31) with a radius of 104 cm the maximum void section (31) depth is approximately 40 mm. This geometry of the void section (36) has been found to create a reduced pressure in the feed section (2) sufficient to prevent the escape of fine particulate matter through the feed inlet (23). Other geometries of the void section (36) may be found to have the same effect. Overall some experimentation been found necessary to get the dimensions of the void section (36) correct, and thus each different size of bottle crusher (1) may have a different void section (31) geometry.

The drum (31) further includes a crusher screen (37) which, when viewed in cross section across the drum (31), extends from approximately the 3 o'clock to the 9 o'clock positions on an analogue clock. The crusher screen (37) is approximately 40% open space, formed by drilling a plurality of holes through the material. It has been found that the thickness of the crusher screen (37) and the diameter of the holes determines the coarseness of the crushed glass produced, for example 9 mm holes in a 6 mm plate produce a crushed glass with 80% of the particulate matter less than about 1 mm in diameter and all below about 2 mm.

The crushing assembly (32) further includes a plurality of assembly plates (40), an assembly shaft (41) and three hammer shafts (42). The centreline of the assembly shaft (41) is coincident with the centreline of the crushing assembly (32). The assembly shaft (41) is directly or indirectly connected to the drive means (5) in a known manner (belt drive, chain drive, directly keyed to the assembly shaft, etc). At present the drive means (5) is an electric motor and it is directly keyed to the assembly shaft (41).

Each assembly plate (40) is a flat metal plate approximately the shape of an equilateral triangle, with each of the vertices rounded. Each assembly plate (40) includes a plate shaft hole (44) and three hammer shaft holes (45).

The plate shaft hole (44) is an aperture through the centre of the assembly plate (40) dimensioned to releasably engage with the assembly shaft (41). In place, each assembly plate (40) lies on a separate plane perpendicular to the centreline of the assembly shaft (41).

Each hammer shaft hole (45) is an aperture through an associated assembly plate (40) located close to one of the vertices of that assembly plate (40) dimensioned to accept a hammer shaft (42). Each hammer shaft hole (45) may be a press fit, or otherwise releasably, but rigidly, attached to the associated hammer shaft (42) or simply restricted in longitudinal movement by the internal surfaces of the casing (30) or drum (31).

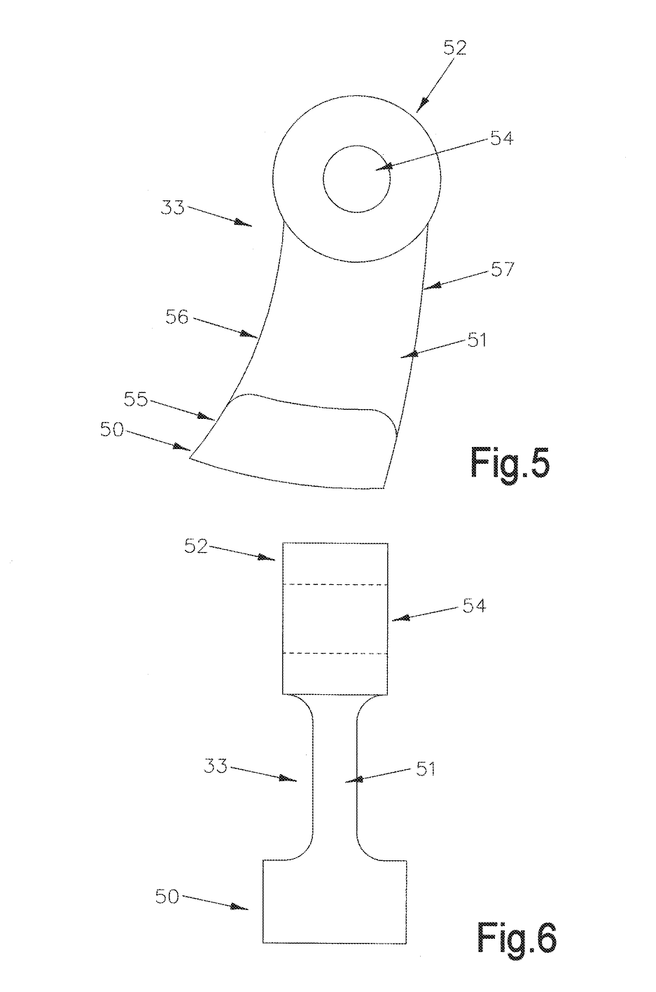

Referring to FIGS. 5 and 6 a hammer (33) including a hammer head (50), hammer body (51) and a hammer tail (52) is shown. The hammer head (50) and hammer tail (52) are located at opposite distal ends of the hammer (33). The hammer body (51) connects the hammer head (50) to the hammer tail (52). The hammers (33) can be made from any suitable material.

Viewed from the front, as shown in FIG. 6, the hammer (33) is “I” shaped, with one cross bar longer than the other, the longer cross bar corresponds to the hammer head (50) and the shorter cross bar corresponds to the hammer tail (52). The hammer tail (52) includes a hinge hole (54). The hinge hole (54) is an aperture located a short distance from the peripheral edge of the hammer tail (52) dimensioned to be a sliding fit onto a hammer shaft (42). The centreline of the hinge hole (54) is coincident with the centreline of the hammer tail (52).

Each hammer head (50) is dimensioned such that in place, as part of the crushing assembly (32), there is a slight (0.5 mm to 2 mm) clearance between immediately adjacent hammer heads (50). It should be noted that as the components wear these clearances may increase but still allow the correct operation of the bottle crusher (1).

The hammer head includes a leading edge (55), which in use first contacts a bottle to be crushed. The hammer body (51) is a flat plate which, when the hammer (33) is viewed from the side, includes two curved peripheral edges (56,57). The first peripheral edge (56) is concave and is the edge on the same side of the hammer (33) as the leading edge (55) of the hammer head (50). The remaining peripheral edge (57) of the hammer body (51) is convex.

The assembly plates (40) are spaced along the assembly shaft (41) with the hammer shaft holes (45) on each assembly plate (40) aligned, with a hammer shaft (42) inserted into each aligned set of hammer shaft holes (45). Between each pair of adjacent assembly plates (40) there is a hammer (33) with the respective hammer shaft (42) passing through the associated hinge hole (54). An assembly plate (40) occupies the terminal position at each end of the crushing assembly (32). Each hammer is freely hinged about its hinge hole (54).

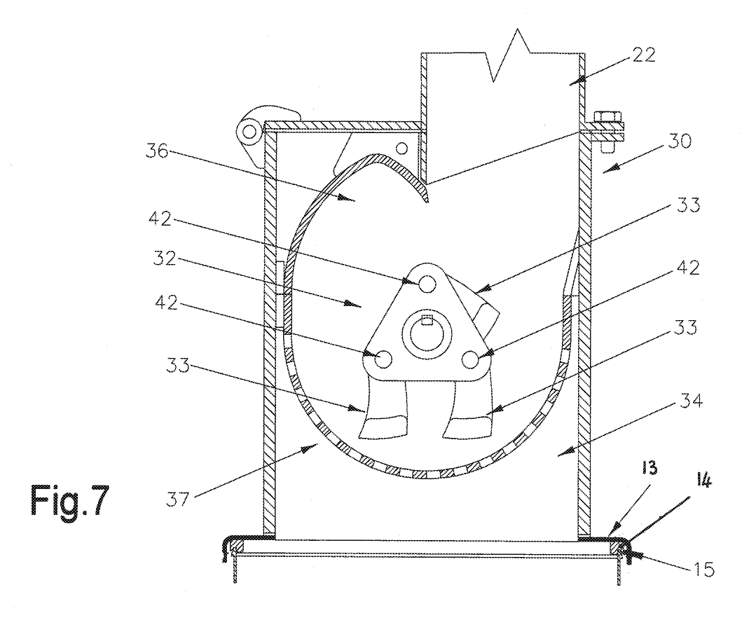

Referring to FIG. 7 the crushing section (3) is shown in cross section with the crushing assembly (32) in the rest position. In this position each of the hammers (33) is free to hang down from its hinge hole (54) under the influence of gravity.

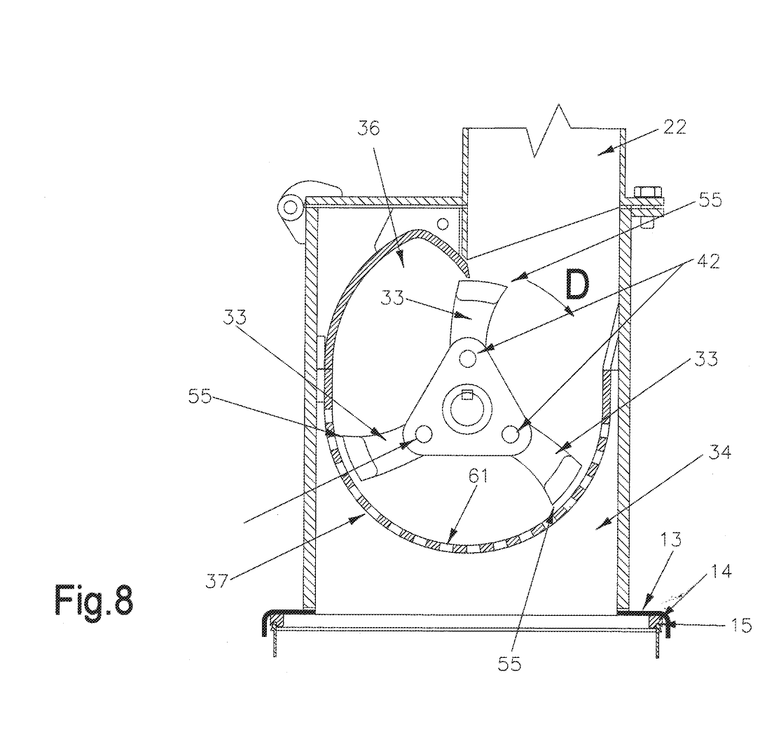

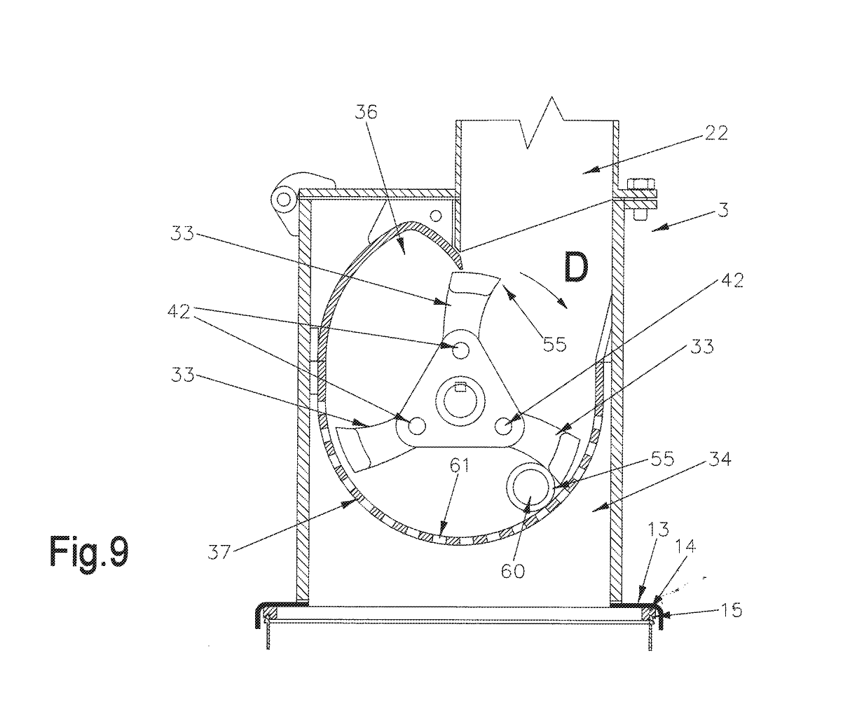

Referring to FIGS. 8 and 9 the crushing section (3) is shown in cross section with the bottle crusher (1) in use, unloaded in FIG. 8 and crushing a bottle (60) in FIG. 9.

In the unloaded position the hammer head (50) of each of the hammers (33) is thrown out towards the inner surface of the drum (31) due to the rotation of the crushing assembly (32). In this embodiment the rotational speed is around 2800 rpm (synchronous-slip) in the direction of Arrow D. The hammers (33) pass from the void section (36) across the crusher inlet (35) and over the crusher screen (37). In this unloaded, but in use, position the closest point of the leading edge (55) of each hammer (33) is about 6 mm away from the inner surface (61) of the crusher screen (37).

In use, each time a hammer (33) strikes a bottle (60) that hammer (33) swings away from the impact, and the clearance between the leading edge (55) of said hammer (33) and the closest point of the inner surface (61) of the crusher screen (37) decreases. The location of the hinge hole (54) and other geometry of the hammer (33) concerned limits the clearance to a minimum of 2.7 mm when hammer (33) and crusher screen (37) are new. The combination of an initial unloaded clearance of 6 mm and a minimum clearance of 2.7 mm, with a 6 mm thick crusher screen (37) with 40% void created by 9.5 mm holes results in a crushed glass material with few if any dangerous sharp edges and a size distribution of about 2% fine talc, 82% less than 1 mm and 97% less than 2 mm.

The geometry of the void section (36) creates a partial vacuum in the feed section (2) causing air to flow from the feed section (2) through the crushing section (3) to exit through the venting section (6) filter (18) minimising or essentially eliminating any dust emissions from the equipment.

In use the bottle crusher (1) is started and a bottle is pushed through the first and second valves, it then falls (or passes) through the feed section (2) and out of the outlet (22) into the crusher inlet (35). As it passes through the crusher inlet (35) it is impacted by one or more hammers (33) and crushed. As each hammer (33) impacts the bottle (60), or resultant crushed material, the hammer (33) swings back reducing the minimum clearance between the hammer (33) and the crusher screen (37). The crushed glass passes through the crusher screen (37) to be collected in the container (11). When the container (11) is full the bottle crusher (1) is shut down and the container (11) removed from the bottle crusher (1) to be emptied and replaced or simply replaced with another container (11).

To remove the container (11) from the bottle crusher (1) the connection section (12), along with the vent section (6), crushing section (3) and the inlet section (2) is lifted upwards and off the container (11). This lifting is preferably accomplished by an inbuilt screw jack, but other means can be used.

In a further embodiment the filter (18) is replaced by a particulate removal device such as a cyclone, electrostatic precipitator or similar.

In a further embodiment (not shown) the centrelines of the crusher assembly (32) and drum (31) are not coincident.

In a further embodiment (not shown) the assembly plates (40) are not essentially triangular in shape, they instead have 4 or more vertices, with a hammer shaft (33) located close to each.

In a further embodiment the shape of the hammers (33) may change geometry from that described, but the decreasing clearance on impact with a bottle (60) remains.

In a further embodiment the crusher screen (37) is not perforated over the full arc, when viewed in cross-section across the drum, between the 3 o'clock and 9 o'clock positions on an analogue clock.

### LIST OF REFERENCE NUMBERS

1 Bottle Crusher
2 Feed Section
3 Crushing Section
4 Collection Section
5 Drive Means
6 Venting Section
11 Container
12 Connection Section
13 Cover
14 Sealing Means
15 Container's exposed edge
18 Filter
20 Duct
21 Feed inlet
22 Feed outlet
23 First Valve
24 Second Valve
25 Flap 1
26 Flap 2
30 Casing
31 Drum
32 Crushing Assembly
33 Hammer
34 Crusher Outlet
35 Crusher inlet
36 Void Section
37 Crusher Screen
40 Assembly Plates
41 Assembly Shaft
42 Hammer Shaft
44 Plate Shaft Hole
45 Hammer Shaft Hole
50 Hammer Head
51 Hammer Body
52 Hammer Tail
54 Hinge Hole
55 Leading Edge
56 First Peripheral Edge
57 Remaining Peripheral Edge
60 Bottle
61 Inner surface

1. A bottle crusher that includes a feed section, a crushing section, a collection section and a venting section, wherein the crushing section is essentially a hammer mill with a crushing assembly inside a drum; such that:—
the crushing assembly includes a plurality of hammers, an assembly shaft and at least two hammer shafts;
each hammer shaft lies essentially parallel to, and is spaced equidistantly from, the assembly shaft to which it is attached;
each hammer includes a hammer tail and a hammer head at opposite distal ends of said hammer, such that each hammer tail is hingedly connected to one hammer shaft; and
the drum and crushing assembly have essentially coincident centrelines;
wherein the drum includes a void section which is an indentation in the inner surface of the drum, when viewed in cross-section across the drum, configured to create a reduced pressure in the feed section, when the crushing section is in use.

2. The bottle crusher as claimed in claim 1 characterised in that the indentation extends from approximately the 9 o'clock position to the 12 o'clock position on an analogue clock.

3. The bottle crusher as claimed in claim 2 characterised in that the void section smoothly curves away from the centre of the drum to a point located at between about the 11:00 o'clock position and 11:45 o'clock position on an analogue clock, then smoothly transitions back to a point on the edge of the circle the same diameter as the drum.

4. The bottle crusher as claimed in claim 2 characterised in that the drum has a radius of about 104 cm and the maximum void section depth, at close to about the 11:30 o'clock position on an analogue clock, is between 20 mm and 60 mm.

5. The bottle crusher as claimed in claim 4 characterised in that the maximum void section depth is between about 30 mm and 50 mm.

6. The bottle crusher as claimed in claim 1 characterised in that the crushing assembly includes at least two assembly plates, such that each hammer shaft is attached to the assembly shaft by the assembly plates, where said assembly plates are spaced along the length of the of the assembly shaft, wherein each hammer is located between two immediately adjacent assembly plates.

7. The bottle crusher as claimed in claim 6 characterised in that each of the hammer shafts is equispaced around the periphery of the assembly plates.

8. The bottle crusher as claimed in claim 6 characterised in that each assembly plate is shaped like an equilateral triangle with rounded vertices with a hammer shaft located close to each vertex.

9. The bottle crusher as claimed in claim 1 characterised in that each hammer is, when viewed from the front, “I” shaped, with one cross bar longer than the other, the longer cross bar corresponding to the hammer head and the shorter cross bar corresponding to the hammer tail.

10. The bottle crusher as claimed in claim 1 characterised in that the drum includes a crusher screen, said crusher screen being a fully or partially perforated plate configured to co-operate with each hammer to break down a bottle being processed.

11. The bottle crusher as claimed claim 10 characterised in that the crusher screen extends, when viewed in cross-section across the drum, from approximately the 3 o'clock position to the 9 o'clock position on an analogue clock.

12. The bottle crusher as claimed in claim 10 characterised in that the perforations in the plate extend essentially the full length of the crusher screen.

13. The bottle crusher as claimed in claim 10 characterised in that, where perforated, the crusher screen is between about 30% and 50% void.

14. The bottle crusher as claimed in claim 10 characterised in that each perforation is a hole between 7 mm and 12 mm in diameter.

15. The bottle crusher as claimed in claim 10 characterised in that the crusher plate is about 6 mm thick has about 40% void and each hole is between 9 mm to 10 mm in diameter.

16. The bottle crusher as claimed in claim 1 characterised in that a minimum clearance between a leading edge of each hammer head, where the leading edge is the part of each hammer configured to first impact a bottle being processed, and an inner surface of the crusher screen is configured to decrease when the bottle is impacted.

17. The bottle crusher as claimed in claim 16 characterised in that the minimum clearance, in an unloaded position i.e. prior to the hammer impacting the bottle, is between 5 mm and 7 mm; where all clearances are given in the as new condition.

18. The bottle crusher as claimed in claim 16 characterised in that the minimum clearance, in a loaded position, i.e. after the hammer has impacted the bottle, is between 2 mm and 4 mm.

19. The bottle crusher as claimed in claim 17 characterised in that the unloaded clearance is about 6 mm and a loaded clearance, i.e. after the hammer has impacted the bottle, is about 2.7 mm.

20. The bottle crusher as claimed in claim 1 characterised in that the bottle crusher is a substantially sealed unit configured to operate with a slightly reduced pressure in the feed section and vent essentially all air exiting through the venting section.

21. The bottle crusher as claimed in claim 1 characterised in that the collection section includes a container configured to collect the crushed glass from the crushing section.

22. The bottle crusher as claimed in claim 1 characterised in that the venting section is configured to reduce a particulate load of air flowing out of the bottle crusher via the venting section.

23. (canceled)

24. The bottle crusher as claimed in claim 1 characterised in that the crushing assembly is driven, directly or indirectly, by a driving means.

25. The bottle crusher as claimed in claim 24 characterised in that the driving means is an electric motor configured to directly rotate the crushing assembly at about 2800 rpm.

26. (canceled)

27. The bottle crusher as claimed in claim 1 characterised in that the bottle crusher is configured to produce a crushed glass with 90% below about 4 mm in size.

28. The bottle crusher as claimed in claim 27 characterised in that about 65% of the crushed glass is 2 mm or less in size.

29. The bottle crusher as claimed in claim 1 characterised in that the feed section includes an inlet with at least one valve, the or each valve being configured to allow a bottle to be fed into the crushing section and assist in maintaining a reduced pressure inside the feed section.

30. (canceled)

31. The bottle crusher as claimed in claim 3 characterised in that the drum has a radius of about 104 cm and the maximum void section depth, at close to about the 11:30 o'clock position on an analogue clock, is between 20 mm and 60 mm.
